(19) United States
(12) Patent Application Publication
(10) Pub. No.: US 2026/0236667 A1
(43) Pub. Date: Aug. 13, 2026

(54) TEXTUAL SUMMARIZATION WITH IMPROVED FOCUS

(71) Applicant: International Business Machines Corporation, Armonk, NY (US)

(72) Inventors: Yi Shan Jiang, Beijing (CN); Ling Zhuo, BEIJING (CN); Yun Wang, BEIJING (CN); Hong Wei Jia, BEIJING (CN)

(73) Assignee: International Business Machines Corporation, Armonk, NY (US)

(21) Appl. No.: 19/049,132

(22) Filed: Feb. 10, 2025

(51) Int. Cl. G06F 40/166; G06F 40/279

(52) U.S. Cl. CPC G06F 40/166; G06F 40/279

(57) ABSTRACT

In a computer-implemented technique of textual summarization, a processor set of a computer system develops a list of relevant entities based on the source text based on receiving a text summarization request and a source text. The processor set also generates an entity set based on an intersection of the list of relevant entities with nodes of a domain knowledge graph for a subject domain of the source text. Based on requestor approval of the entity set, the processor set generates, utilizing a LLM engine, a text summary of the source text that explicitly mentions each entity in the entity set.

### BACKGROUND OF THE INVENTION

The present invention relates in general to data processing and, in particular, to textual summarization with improved focus.

Computer-aided textual summarization has recently advanced significantly, largely due to the shift in the summarization processing paradigm from user-supervised fine-tuning operating on labeled datasets to zero-shot prompting with Large Language Models (LLMs).

In theory, as a compression of another text, a textual summary should be denser than the source text, that is, the textual summary should contain a higher concentration of information than the source text. However, the desired density of the textual summary is an open question. A summary without enough details is uninformative, and a summary containing too many details can be too long relative to the length of the source text. Further, the specific details that are desirable to include in the textual summary can differ depending on the type of source text and audience of the textual summarization.

### SUMMARY OF THE INVENTION

In one or more embodiments of a computer-implemented technique of textual summarization, a processor set of a computer system develops a list of relevant entities based on the source text based on receiving a text summarization request and a source text. The processor set also generates an entity set based on an intersection of the list of relevant entities with nodes of a domain knowledge graph for a subject domain of the source text. Based on requestor approval of the entity set, the processor set generates, utilizing a LLM engine, a text summary of the source text that explicitly mentions each entity in the entity set.

### BRIEF DESCRIPTION OF THE DRAWINGS

FIG. 1 is a high-level block diagram of an exemplary data processing environment in accordance with one or more embodiments;

FIG. 2 depicts a more detailed view of an exemplary text summarization tool in accordance with one or more embodiments;

FIG. 3 is a high-level logical flowchart of an exemplary process for summarizing a source text in accordance with one or more embodiments; and

FIG. 4 depicts an exemplary domain knowledge graph in accordance with one or more embodiments.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION OF ILLUSTRATIVE EMBODIMENT

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing.

Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as text summarization tool 200. In addition to text summarization tool 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and text summarization tool 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

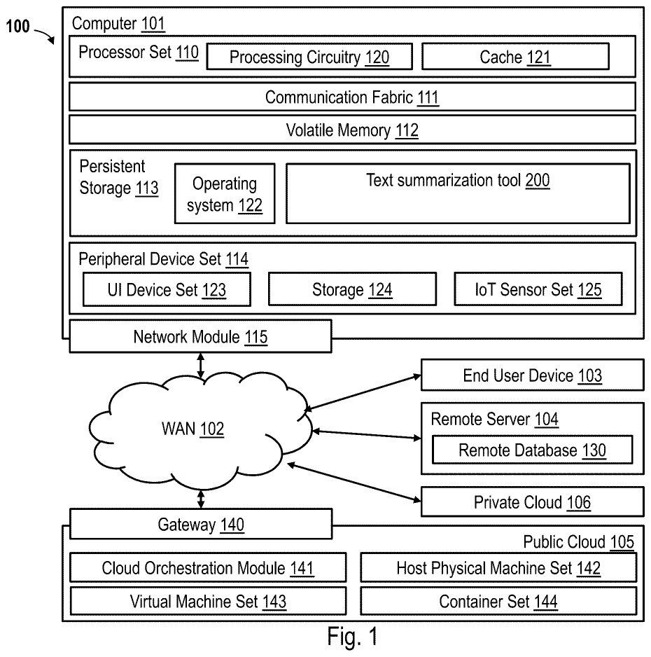

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data and re-writing of data. Some familiar forms of persistent storage include magnetic disks and solid state storage devices.

Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the Internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Those of ordinary skill in the art will appreciate that the architecture and components of a data processing environment can vary between embodiments. Accordingly, the exemplary computing environment 100 given in FIG. 1 is not meant to imply architectural limitations with respect to the claimed invention.

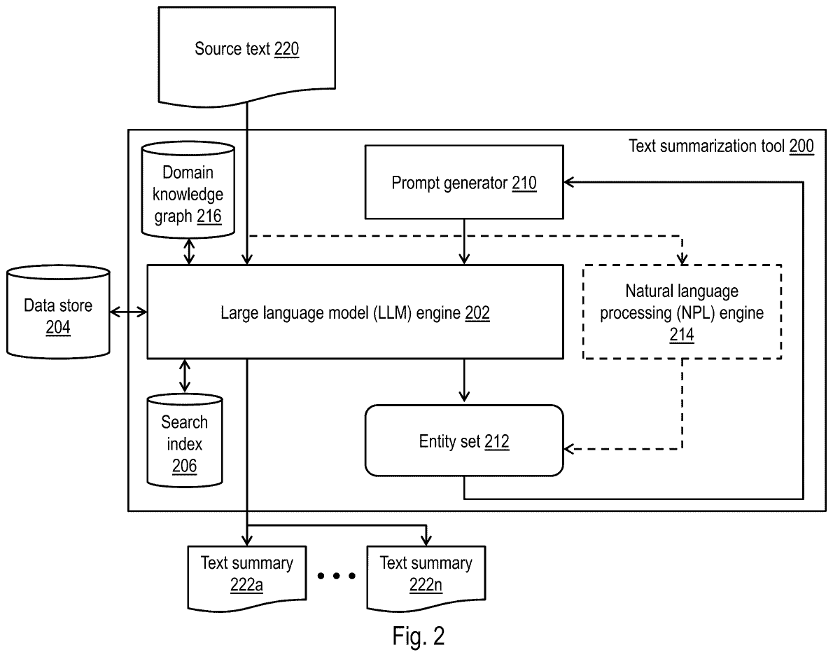

Referring now to FIG. 2, there is depicted a more detailed view of an exemplary text summarization tool 200 in accordance with one or more embodiments. In the illustrated example, text summarization tool 200 includes a large language model (LLM) engine 202, which, as known in the art, can be perform a number of functions on natural human languages, including analyzing, translating, summarizing, interpreting, and generating natural human language text, as well as processing other forms of unstructured data. LLM engine 202 acquires increasing proficiency at these tasks by applying deep learning to textual information (e.g., websites, documentation, technical and other literature, reference materials, blog posts, procedures, etc.) in a data store 204, which can include private data sets and/or public data sets (including Internet-accessible data) accessible in computing environment 100. LLM engine 202 typically maintains a search index 206 of information referenced in data storage 204 to facilitate rapid access.

Text summarization tool 200 additionally includes a prompt generator 210, which generates prompts for LLM engine 202. These prompts include requests for LLM engine 202 to summarize a source text 220 composed in a natural human language to obtain one or more text summaries 222a-222n of source text 220. In accordance with at least some embodiments, prompt generator 210 generates the summarization prompts for LLM engine 202 based at least in part on an entity set 212 specifying entities in source text 220 for which details would be most relevant for inclusion in a text summary 222a-222n. In some embodiments or use cases, LLM engine 202 can be utilized to generate entity set 212 from source text 220. In other embodiments or use cases, entity set 212 can alternatively or additionally be generated from source text 220 by a natural language processing (NLP) engine 214.

Although FIG. 2 illustrates LLM engine 202 as forming a component of text summarization tool 200, those skilled in the art will appreciate that, in some embodiments, LLM engine 202 may be a publicly available LLM engine, such as those available over the Internet.

Although not limited to such applications, in at least some embodiments or use cases, text summarization tool 200 can be applied, for example, to automate technical support operations of an enterprise, which may have a computing environment like computing environment 100 of FIG. 1. In such embodiments or use cases, source text 220 can include one or more technical support requests and/or a technical support log documenting a history of support actions taken to support the hardware and/or software components employed in the data processing operations of the enterprise. As will be appreciated, in many cases, technical support of an enterprise may be provided through multiple different technical support teams, each having a respective support focus or expertise. For example, a first support team may have expertise in software integration, a second support team may be expertise in software containerization, and third support team may have expertise in hardware troubleshooting and maintenance, a fourth support team may have expertise in communication networks, and so on. As a consequence of the different areas of focus or expertise, it would be useful and desirable for each support team to be provided with a respective different text summary 222a-222n of source text 220 that is specifically tailored to provide more details regarding entities referenced or inferred by the source text 220 that are relevant to the support services provided by that support team while eliding other details present in source text 220 that are not relevant to that support team. Thus, text summarization tool 200 can generate multiple different summaries of the same source text 220 that vary depending upon the entity set 212 upon which prompt generator 210 generates a text summarization prompt.

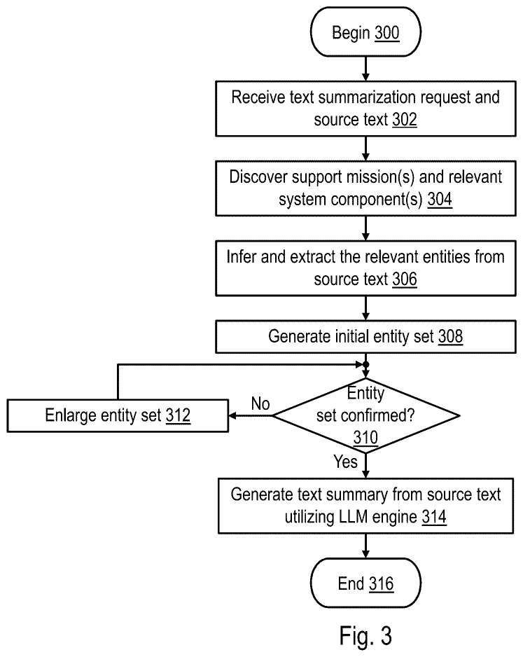

With reference now to FIG. 3, there is illustrated a high-level logical flowchart of an exemplary process of textual summarization of source text in a natural human language in accordance with one or more embodiments. The illustrated process can be performed, for example, through the execution of text summarization tool 200 by processor set 110 of computer 101 of FIG. 1. This specific process depicted in FIG. 3 applies the process of textual summarization to the field of technical support. Those skilled in the art will appreciate that similar processes can be adapted and implemented for application to other fields of endeavor.

The process of FIG. 3 begins at block 300 and then proceeds to block 302, which illustrates text summarization tool 200 receiving a text summarization request and a source text 220. As noted above, in the described example, the text summarization request may originate from one of multiple support teams supporting the computing environment 100 of an enterprise, and the source text 200 may include a user's technical support request outlining a problem to be corrected in the computing environment 100, a request for an enhancement and/or addition to the computing environment 100, and/or a request for a modification to the computing environment 100. In addition, source text 200 may include a technical support log, which may include log entries documenting historical support activities of both the support team making the text summarization request and/or other support teams.

In response to receipt of the text summarization request and source text 220 at block 302, text summarization tool 200 discovers the support mission(s) to be accomplished and the components of computing environment 100 relevant to the support mission(s) to be accomplished (block 304). In at least some some embodiments, text summarization tool 200 discovers the support mission(s) to be accomplished based on information known or inferred about the requestor (e.g., support team membership information and/or associated expertise) and/or textual content of the source text 220. Similarly, text summarization tool 200 can discover the components of computing environment 100 relevant to the support mission(s) based on the requestor and/or content of the source text 220. In some embodiments, text summarization tool 200 can discover the support mission(s) relevant components by reference to a domain data structure, such as a domain knowledge graph 216.

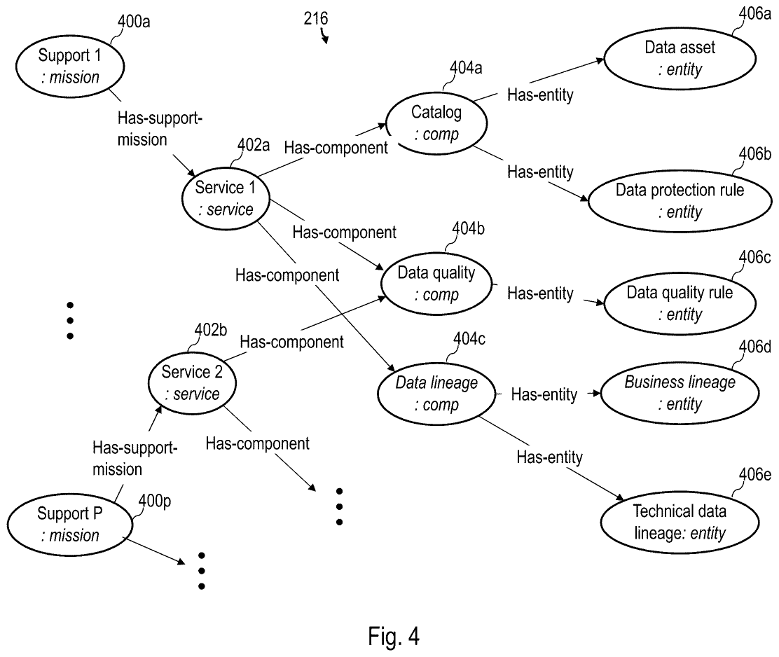

Referring now to FIG. 4, there is depicts a partial view of an exemplary domain knowledge graph 216 in accordance with one or more embodiments. As is known to those skilled in the art, a domain knowledge graph is a graph-based data structure that stores data regarding linguistic concepts, which are represented in domain knowledge graph 216 as nodes, and the relationships between those linguistic concepts, which are represented as edges. In the particular domain knowledge graph 216 depicted in FIG. 4, various different technical support “missions”, including those represented by mission nodes 400a to 400p, are related to “entities”, including those represented by entity nodes 406a to 406e. In this example, the relationships between “missions” and “entities” are established via one or more “services,” including those represented by service nodes 402a and 402b, and one or more “components”, including those represented by component nodes 404a to 404c. The various types of relationships between nodes (e.g., has-support-mission, has-component, has-entity) are specified by the edges. Those skilled in the art will appreciate that in at least some embodiments, text summarization tool 200 may include or have access to multiple different domain knowledge graphs, each pertaining to a respective subject (or problem) domain.

Returning to block 304 of FIG. 3 and still referring to FIG. 4, text summarization tool 200 can discover the support mission and relevant system components through exploration of domain knowledge graph 216. For example, text summarization tool 200 may enter domain knowledge graph 216 at one of nodes 400a to 400p selected based on the mission of the technical support team that originated the textual summarization request or based on a fuzzy match between textual content of a most recent support request in source text 220. Text summarization tool can then identify the set of relevant components of computing environment 101 by reference to the component nodes 404 connected to the selected one of mission nodes 400a-400p in domain knowledge graph 216.

At Block 306 of FIG. 3, text summarization tool 200 develops, from source text 220, a complete list of entities that may possibly be mentioned by name in text summary 222. In at least some embodiments, text summarization tool 200 develops the complete list of entities that may be mentioned utilizing LLM engine 202 and/or NPL engine 214. The complete list of entities may include both those explicitly named in source text 220, as well as those inferred, for example, by reference to data store 204. As a simple example, source text 220 may omit specific reference to an operating system 122 or other necessary component of a given operating environment, but LLM engine 202 may nevertheless infer its presence in a computing environment 100 (and mention it in a text summary 222) based on information referenced by LLM engine 202 in data store 204. Although NLP engine 214 can optionally be utilized to develop the list of entities, use of the same LLM engine 202 to both develop both the entity listing at block 306 and generate text summary 222 generally results in more optimal performance.

Text summarization tool 200 next generates an initial entity set 212 (block 308). In at least one embodiment, LLM engine 202 generates the initial entity set by including in entity set 212 those entities named in the list of entities developed at block 306 that have a relationship, specified in domain knowledge graph 216, with a system component discovered at block 304. In this embodiment, the intersection of list of entities developed from source text 220 and data store 204 and the relevant entities determined by reference to domain knowledge graph 216 form an initial entity set 212. As indicated at blocks 310-312, the requesting user has the option to confirm the existing entity set as sufficient for text summary 222 (block 310) or to enlarge the entity set 212 (block 312) by including additional user-selected entities from the list of entities developed at block 306. The enlargement of entity set 212 can continue iteratively until the user is satisfied that all relevant entities to be explicitly named in text summary 222 are have been added to entity set 212.

In response to an affirmative determination at block 310, prompt generator 210 supplies the user-approved entity set 212 to LLM engine 202 as a prompt and initiates generation, by LLM engine 202, of a text summary 222 of source text 220. As noted above, the text summary 222 will explicitly include, by name, each entity specified included in the approved entity set 212. Thus, the disclosed technique of textual summarization enables the focus of the resulting text summary 222 to be tailored for the intended audience based on keywords specified by the requestor. Consequently, different text summaries 222a-222n o the same source text 220 can be generated, for example, for different technical support teams. It should also be noted that the disclosed process does not require recursive processing of a text summary by LLM engine 202, a function not supported, for example, by all smaller, open-sourced LLMs.

As has been described, in one or more embodiments of a computer-implemented technique of textual summarization, a processor set of a computer system develops a list of relevant entities based on the source text based on receiving a text summarization request and a source text. The processor set also generates an entity set based on an intersection of the list of relevant entities with nodes of a domain knowledge graph for a subject domain of the source text. Based on requestor approval of the entity set, the processor set generates, utilizing a LLM engine, a text summary of the source text that explicitly mentions each entity in the entity set.

While the present invention has been particularly shown as described with reference to one or more preferred embodiments, it will be understood by those skilled in the art that various changes in form and detail may be made therein without departing from the spirit and scope of the invention.

The following definitions are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, system or apparatus that comprises a list of elements is not necessarily limited to only those elements but can include other elements not expressly listed or inherent to such composition, mixture, process, method, article, system or apparatus.

Additionally, the term “exemplary” is used herein to mean “serving as one example, instance or illustration.” Any embodiment or design described herein as “exemplary” is not necessarily to be construed as preferred or advantageous over other embodiments or designs. The terms “at least one” and “one or more” shall be understood to include any integer number greater than or equal to one, and the term “plurality” shall be understood to include any integer number greater than or equal to two. The term “coupled” shall include both indirect connection and a direct connection, unless specified otherwise in a particular case. The terms “about,” “substantially,” “approximately,” and variations thereof, are intended to include the degree of error associated with measurement of the particular quantity based upon the equipment available at the time of filing the application. For example, “about” can include a range of ±10% or ±5%, or ±2% of a given value.

The figures described herein and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. For the sake of brevity, conventional techniques related to making and using aspects of the invention(s) may or may not be described in detail herein, and many conventional implementation details are only mentioned briefly or are omitted entirely. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a” is not intended as limiting of the number of items.

What is claimed is:

1. A computer-implemented method of textual summarization, the method comprising:
based on receiving a text summarization request and a source text, a processor set of a computer system developing a list of relevant entities based on the source text;
the processor set generating an entity set based on an intersection of the list of relevant entities with nodes of a domain knowledge graph for a subject domain of the source text; and
based on requestor approval of the entity set, the processor set generating, utilizing a LLM engine, a text summary of the source text that explicitly mentions each entity in the entity set.

2. The computer-implemented method of claim 1, further comprising:
prior to the generating, the processor set, based on requestor input, enlarging the entity set to include at least one additional entity from the list of relevant entities.

3. The computer-implemented method of claim 1, wherein developing the list of relevant entities includes the processor set, based on a data set accessed by the LLM engine, including in the list of relevant entities at least one entity not named in the source text.

4. The computer-implemented method of claim 1, wherein developing the list includes the processor set utilizing natural language processing of the source text to develop list of relevant entities.

5. The computer-implemented method of claim 1, wherein generating the text summary includes generating, from the source text, multiple different text summaries including the text summary.

6. The computer-implemented method of claim 1, wherein the source text includes a technical support log of a computing environment.

7. A computer program product, comprising:
one or more computer-readable storage media; and
program instructions stored on the one or more computer-readable storage media to perform operations including:
based on receiving a text summarization request and a source text, a processor set of a computer system developing a list of relevant entities based on the source text;
the processor set generating an entity set based on an intersection of the list of relevant entities with nodes of a domain knowledge graph for a subject domain of the source text; and
based on requestor approval of the entity set, the processor set generating, utilizing a LLM engine, a text summary of the source text that explicitly mentions each entity in the entity set.

8. The computer program product of claim 7, wherein the operations further include:
prior to the generating, the processor set, based on requestor input, enlarging the entity set to include at least one additional entity from the list of relevant entities.

9. The computer program product of claim 7, wherein developing the list of relevant entities includes the processor set, based on a data set accessed by the LLM engine, including in the list of relevant entities at least one entity not named in the source text.

10. The computer program product of claim 7, wherein developing the list includes the processor set utilizing natural language processing of the source text to develop list of relevant entities.

11. The computer program product of claim 7, wherein generating the text summary includes generating, from the source text, multiple different text summaries including the text summary.

12. The computer program product of claim 7, wherein the source text includes a technical support log of a computing environment.

13. A computer system, comprising:
a processor set;
one or more computer-readable storage media; and
program instructions stored on the one or more computer-readable storage media to cause the processor set to perform operations including:
based on receiving a text summarization request and a source text, developing a list of relevant entities based on the source text;
generating an entity set based on an intersection of the list of relevant entities with nodes of a domain knowledge graph for a subject domain of the source text; and
based on requestor approval of the entity set, generating, utilizing a LLM engine, a text summary of the source text that explicitly mentions each entity in the entity set.

14. The computer system of claim 13, wherein the operations further include:
prior to the generating and based on requestor input, enlarging the entity set to include at least one additional entity from the list of relevant entities.

15. The computer system of claim 13, wherein developing the list of relevant entities includes the processor set, based on a data set accessed by the LLM engine, including in the list of relevant entities at least one entity not named in the source text.

16. The computer system of claim 13, wherein developing the list includes the processor set utilizing natural language processing of the source text to develop list of relevant entities.

17. The computer system of claim 13, wherein generating the text summary includes generating, from the source text, multiple different text summaries including the text summary.

18. The computer system of claim 13, wherein the source text includes a technical support log of a computing environment.
